(19) United States
(12) Patent Application Publication
(10) Pub. No.: US 2006/0179760 A1
(43) Pub. Date: Aug. 17, 2006

(54) Acoustic wall using compressed fiber panels

(76) Inventor: John Parker Burg, McKinney, TX (US)

Correspondence Address: Robert H. Frantz, P.O. Box 23324, Oklahoma City, OK, 73123, US

(21) Appl. No.: 11/060,134

(22) Filed: Feb. 17, 2005

(51) Int. Cl. E04B 9/00; E06B 3/54

(52) U.S. Cl. 52/479

(57) ABSTRACT

A sound insulating wall construction for improving acoustics in commercial buildings, theaters and the like having a multi-layer construction formed from at least three compressed strawboard panels in adjacent and generally parallel planar alignment and defining spaces in between which can be hollow or filled with insulating medium. Each panel is held in place by opposed edge bracket assemblies positioned to clasp the ends of each panel. The bracket assemblies include a resilient material acting to isolate or decouple each panel. The strawboard panels are positioned so that horizontal panel to panel joints in each layer are offset to eliminate easy burn through areas. Edge brackets are generally mounted to vertical I-beams and can be adapted for use with a variety of beam types.

### BACKGROUND OF THE INVENTION

1. Field of the Invention

This invention relates to methods and structures for constructing walls which have specific acoustic characteristics, such as theater and auditorium walls.

2. Background of the Invention

The primary function of interior walls and partitions is to divide building space into separate, private spaces. Many other factors, however, must be considered by designers and builders, one of which is sound control. In hotels, for example, the prevention of sounds originating in one room from passing through walls and into adjacent rooms is of major concern. This consideration is extremely important in the design and construction of multi-screen movie theaters or home media rooms.

Conventional wall construction techniques tend to rely on a stud frame interior with wall covering panels comprised of gypsum board, plywood or other largely modular panels. Interior walls in offices, hotels and the like are typically made by erecting a frame that includes vertical studs, either wood or steel, on a 12″ or 16″ spacing, lining each side with gypsum board (sheet rock) panels, then finishing the wall surfaces with a variety of textures and paint. When additional thermal and/or acoustic insulation is needed, insulation medium such as fiberglass, rock wool or mineral wool will commonly be placed to fill the interior space between vertical studs and gypsum board panels. Sound transmission through walls can be reduced by widening the wall and staggering the studs such that no stud spans the full width of the wall. Sound transmission is often further reduced by surface or exterior treatments such as the application of light, resilient materials like carpeting, folded or layered upholstery, or the like.

Sound transmission through walls is typically expressed according to one of two single-number rating systems—Sound Transmission Class (STC) and Weighted Sound Reduction Index (Rw). Both are single-figure ratings schemes intended to rate the acoustical performance of a partition element under typical conditions involving office or dwelling separation. The higher the value of either rating, the better the sound insulation. The rating is intended to correlate with subjective impressions of the sound insulation provided against the sound of speech, radio, television, music, office machines and similar sources of sound characteristic of offices and dwellings.

The first rating system is called Sound Transmission Class (STC). STC is defined by the American Society for Testing Materials (ASTM) standard E 413. To assign an STC rating to a barrier separating two rooms, a sound is generated in one of the rooms, the sound power is measured on both sides of the barrier, and the ratio between the two measurements (the transmission loss) is stated in decibels. Sixteen measurements are made in each room, at ⅓ octave intervals from 125 Hz to 4000 Hz. The higher the STC rating, the greater the sound transmission loss. The E413 standard specifies a transmission loss curve having 16 points on the same ⅓ octave intervals. From 125 to 40 Hz, the curve slopes 9 dB per octave; from 400 Hz to 1250 Hz, 3 dB per octave, and it is flat from 1250 Hz to 4000 Hz. The curve is moved up and down until the sum of all 16 differences between the curve's value and the measured values for the barrier is less than 32 dB (providing no single difference is more than 8 dB). The rating is then expressed as the curve's loss in decibels at 500 Hz.

The second rating system is called Weighted Sound Reduction Index (Rw) and is defined by International Standards Organization standard ISO 717. Test procedure for Rw are similar to STC except the frequency range for Rw spans 100-3150 Hz whereas, as indicated supra, STC covers a frequency range of 125-4000 Hz. STC and Rw correlate very well. For architectural elements such as doors, windows and walls, differences in STC and Rw are typically less than 1%.

When sound waves strike a surface, some of the energy is usually reflected while some is transmitted through the surface. A typical objective in reducing sound transmission through a structure is to isolate the source from the structure before the energy can be transmitted to the structure, causing the structure to vibrate. The primary ways to reduce sound transmission through multi-component structures is to add mass and to decouple or isolate individual components so that vibrations cannot be passed from one component to the next.

Decoupling can be done in many ways and is the subject of much development. Typically, decoupling is done by means of soft, resilient and/or generally bulky materials. Isolated or still air is an effective decoupler and there are many applications wherein the insulation of sound and heat are accomplished analogously. Decoupling can be enhanced by the use of viscoelastic materials, typically high molecular weight polymers, to isolate components and reduce contact between larger or more rigid components. The viscoelastic materials, in effect, allow the larger and/or more rigid components to vibrate independently and, more importantly, act to dampen the vibration of the components.

Viscoelastic materials, as the name implies, exhibit both elastic and viscous properties and are generally modeled using a combination of springs and dashpots. Springs simulate elastic behavior while dashpots simulate viscous behavior. When a viscoelastic material is made to vibrate, a complex strain is generated on the material thereby generating a complex stress. The elastic modulus (E) is known to be the ratio of stress (s) and strain (e) in a material and can be described as the amount of strain resulting from an applied stress (E=s/e). In a viscoelastic material, the elastic modulus is comprised of two components, a storage elastic modulus (ES) which results from the elastic properties of the material, and a loss elastic modulus (EL) resulting from the viscous properties of the material. The ratio of loss modulus to storage modulus is called loss tangent (tan d) and is the mathematic ratio between the two (tan d=EL/ES). The loss modulus component corresponds to a materials ability to convert dynamic energy to electric or thermal energy, thus an ability to dampen vibrations. It follows that as a materials tan d increases, so does that materials ability to dampen vibrations.

Decoupling can also be achieved by means of resilient channel members used as part of a wall construction. Resilient channels, typically transversely mounted, act to absorb vibrational energy instead of transmitting the energy from one wall component to the next. Historically, however, less than optimum construction and installation practices effectively lead to acoustic short circuits around resilient channels negating their full effect.

Another technology often employed is the use of panels comprised of a honeycomb core. In some cases, the cells of the honeycomb core effectively trap dead air which is a relatively poor acoustic conductor. In more sophisticated applications, the individual honeycomb cells may be designed as interconnected Helmholtz resonators which dissipate acoustic energy by allowing the viscous laminar flow of air between resonators.

It is known that sound insulation is best obtained from multi-shell components wherein both the mass and the resiliency of the components are factors, thus a best combination of weight and bulk is typically sought New materials, namely novel viscoelastic polymers included as part of layered panels or are finding use in high STC wall construction, but these materials tend to be expensive and remain largely unproven.

### SUMMARY OF THE INVENTION

The present invention includes a structure and a method for building the structure for a sound insulating wall. The sound insulating wall is useful for improving acoustics in commercial buildings, theaters. It has a multi-layer construction formed from at least three compressed strawboard panels in adjacent and generally parallel planar alignment and defining spaces in between which can be hollow or filled with insulating medium. Each panel is held in place by opposed edge bracket assemblies positioned to clasp the ends of each panel. The bracket assemblies include a resilient material acting to isolate or decouple each panel. The strawboard panels are positioned so that horizontal panel to panel joints in each layer are offset to eliminate easy burn through areas. Edge brackets are generally mounted to vertical I-beams and can be adapted for use with a variety of beam types.

### BRIEF DESCRIPTION OF THE DRAWINGS

The present invention should be more fully understood when the written description is considered in conjunction with the drawings contained herein, wherein:

FIG. 1 shows an isometric view of a section of finished wall constructed according to the embodiments disclosed herein;

FIG. 2 shows a cutaway top view of a wall section showing a back, front, and center panel held between opposed I-beams;

FIG. 3 shows a detailed cutaway top view of a wall joint including the components utilized to make connection between I-beams and panels;

FIG. 4a-4i show isometric views of the progressive steps followed to erect a wall according to subject embodiments;

FIG. 5 is a isometric composite view of a single strawboard panel;

FIG. 6 is an isometric view of a section of finished wall constructed on a sloped floor;

FIG. 7 is a detailed cutaway top view of alternative embodiments of subject retainer plate; and

FIG. 8 is a detailed cutaway top view of alternative embodiments of subject angle bracket and channel bracket.

### DETAILED DESCRIPTION OF THE INVENTION

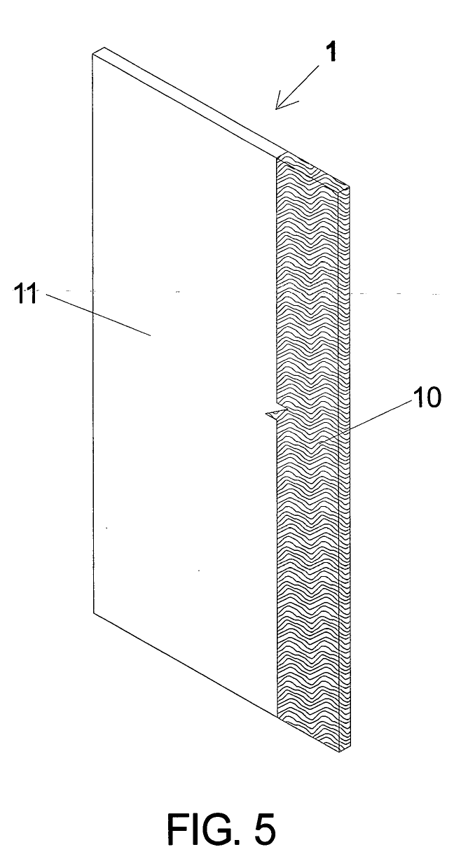

The improved construction disclosed herein includes a number of individual components, but is generally designed around a compressed straw panel. In the preferred embodiment, compressed straw panels such as those manufactured by Durra Building Systems of Texas are used. Each compressed straw panel is composed of highly compressed straw, typically wheat, rice, oat or other recovered agricultural straw lined on all exterior sides by paper or paperboard. Compressed straw panels are typically made through a dry extrusion process wherein straw is compressed into a substantially flat continuous web, normally between 1″ and 3″ thick and between 30″ and 65″ wide. As previously mentions, the continuous web is lined on all sides by paper or paperboard. The continuous web is then cut into rectangular panels of various lengths. FIG. 5 is an isometric composite view of a simple compressed straw panel 2 showing the compressed straw fibers 12 and the paperboard liner 13. The compressed straw fibers 12 are arranged in layers with the straw fibers substantially parallel in orientation extending transversely across the panel from side to side when the panel is in an upright orientation. For reference, a typical completed panel will measure 4′×8′. Compressed straw panels are highly rigid and can be used in any orientation. In the embodiments disclosed herein, said panels are oriented such that the longer edges are substantially horizontal and the shorter edges are substantially vertical. In this orientation, said compressed straw fibers 12 will assume a generally vertical orientation.

The acoustic and combustion properties of the compressed straw panels are of particular importance to the embodiments disclosed herein. A typical 2¼″ thick panel has a Class A flame spread rating (FSI=10, SDI=45) as tested and rated according to ASTM E-84, and an STC and Rw rating of 36 as tested and rated according to ASTM E90-99, E413-87, E1132-90, and ISO 717. Further, the preferred compressed straw panels disclosed herein each provide a one hour fire rating on both sides as tested and rated according to ASTM E-119.

The desirable acoustic properties of compressed strawboard panels is not fully understood, but it is asserted that two primary factors are involved. First, straw is a cellulosic material, thus when dried, is comprised of many substantially hollow cells. Further, a significant amount of dead air is trapped in small spaces between individual straw fibers within a panel. Second, the individual straw fibers within a panel are not glued or otherwise bonded together, thus it is plausible that a quasi-viscous flow can occur within a panel.

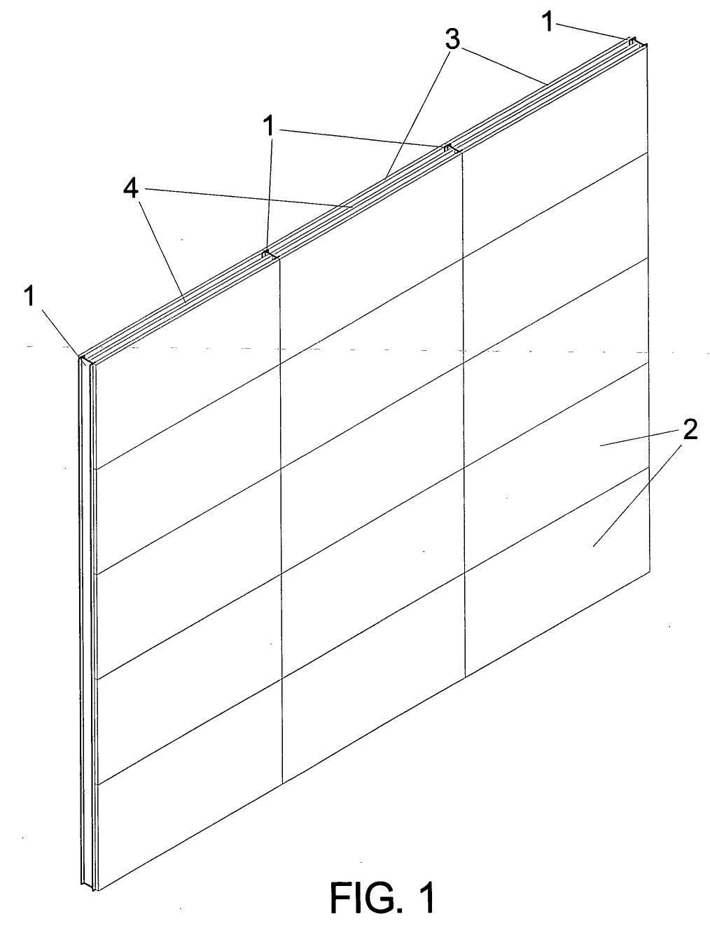

FIG. 1 shows a section of wall constructed according to the preferred embodiment comprised of a plurality of I-beams 1 horizontally arrange and regularly spaced along a wall line 14 with a plurality of front strawboard panels 2 arranged in an edge to edge manner so as to form a front wall face. Though mostly hidden from view, a rear wall face is comparably comprised of a plurality of strawboard panels 3. An inside barrier wall is comprised of center strawboard panels 4 in edge to edge arrangement and positioned to span the distance between said I-beams 1. Each strawboard panel 2,3,4, regardless of location, is attached to two I-beams. The specific means for attachment is disclosed herein.

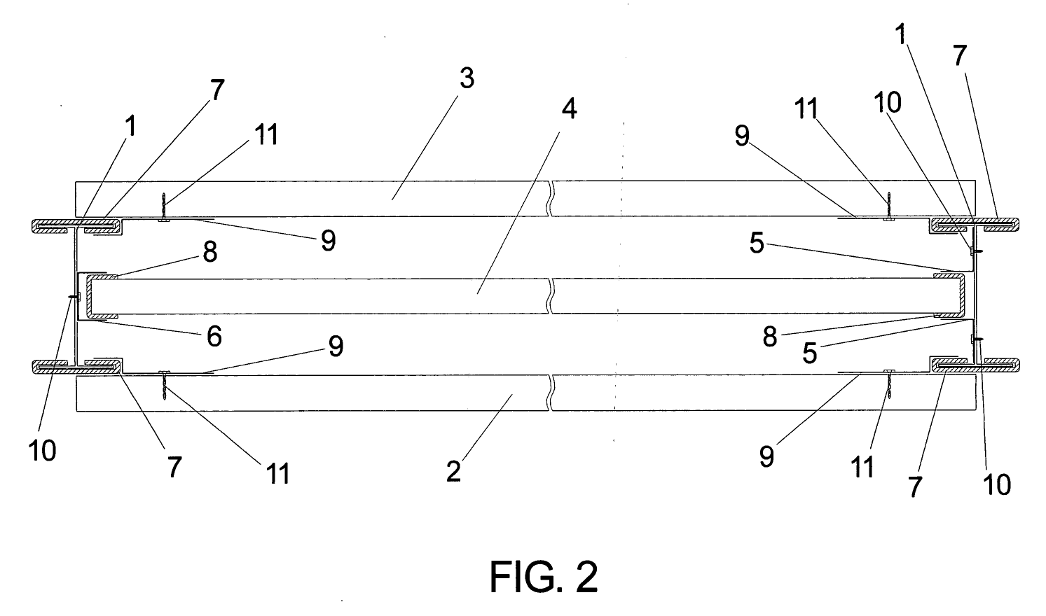

FIG. 2 shows a cutaway top view of a wall section spanning between two I-beams. First I-beam 1 and second I-beam 1′ are spaced and in substantially parallel alignment. The flange portion of each I-beam is covered by a flange decoupling pad 7 which acts to decouple the components with which it makes contact by effectively dampening and absorbs vibrational energy. Continuing, front strawboard panel 2 is substantially centered between said I-beams and in generally flush proximity to the near flanges of said I-beams. Front strawboard panel 2 is held in place by means of retainer plates 9 situated along the two vertical edges of said strawboard panel. Retainer plates 9 are held in place by a plurality of lag screws 11. Though not apparent from the illustration in FIG. 2, each retainer plate 9 is in substantially parallel alignment with the respective vertical edge of said front strawboard panel 2. Each lag screw 111 penetrates through said retainer plate 9 and terminates in said front strawboard panel 2 as shown. In the preferred embodiment, 1½″ lag screws are used, but other penetrating connectors such as nails, screws, brads or the like can easily be used.

Continuing with FIG. 2, rear strawboard panel 3 is substantially centered between said I-beams and in generally flush proximity to the rear flanges of said I-beams, and held in place by means of retainer plates 9 situated along the two vertical edges. Each retainer plate 9 is held in place by a plurality of lag screws 11, and is in substantially parallel alignment with the respective vertical edge of said rear strawboard panel 3. Lag screws 11 penetrates through said retainer plate 9 and terminates in said rear strawboard panel 3 as shown. In the preferred embodiment, 1½″ lag screws are used.

Center strawboard panel 4 is situated along the centerline of the wall and spans the distance between the web sections of said I-beams 1. Center strawboard panel 4 is held in place along a first vertical edge by means of a channel bracket 6, with said channel bracket being attached to the web of an I-beam 1 by means of a plurality of tapping screws 10. Each tapping screw 10 penetrates through said channel bracket 6 and makes a rigid attachment to the web of an I-beam 1. Center strawboard panel 4 is held along a second vertical edge my means of a pair of angles brackets 5 in opposed relative arrangement so as to sandwich the edge of center panel 4 there between. As illustrated, each angle bracket 5 is attached to I-beam 1 by means of a plurality of tapping screws 10, each of which penetrate through said angle bracket 5 and then form a rigid attachment to the web of an I-beam 1. The vertical edges of center panel 4 are separated from either channel bracket 6 or angle brackets 5 by means of an edge decoupling pad 8. Said decoupling pads 8, each act to decouple the center panel 4 from channel bracket 6 and angle brackets 5 respectively by effectively dampening and absorbing vibrational energy. Tapping screws 10 represent the preferred connector for attaching angle brackets 5 and channels brackets 6, but alternative connectors such as rivets, bolts, welds or the like can be used as well.

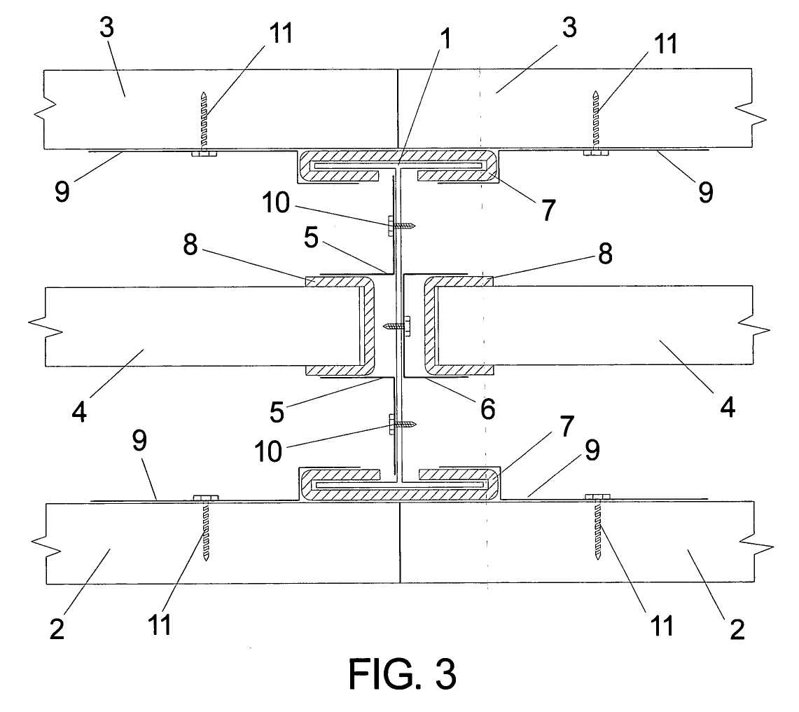

FIG. 3 shows a cutaway detailed top view of a wall joint comprising an I-beam 1, two front strawboard panels 2, two rear strawboard panels 3, two center strawboard panels 4, retainer plates 9, lag screws 11, channel bracket 6, angle brackets 5, tapping screws 10, flange decoupling pads 7, and edge decoupling pads 8. Front strawboard panels 2 are each held in place by a retainer plate 9 which is attached to each panel by means of a plurality of lag screws 11. Direct contact between front strawboard panels 2 and I-beam 1 is prevented by means of flange decoupling pad 7 which is effectively wrapped around the outer flanges of each I-beam 1 prior to placement of strawboard panels. As mentioned, flange decoupling pad 7 acts to prevent the transfer of acoustic or vibrational energy from said front strawboard panels 2 to said I-beam 1. Likewise, rear strawboard panels 3 are each held in place by a retainer plate 9 which is attached to each panel by means of a plurality of lag screws 11. Direct contact between rear strawboard panels 3 and I-beam 1 is prevented by means of flange decoupling pad 7 which acts to prevent the transfer of acoustic or vibrational energy from said rear strawboard panels 3 to said I-beam 1.

Retainer plate 9 is sized such that upon installation, flange decoupling pad 7 is in solid contact with a panel 2,3 and said retainer plate 9, but remains in a substantially non-compressed state. This is critical when flange decoupling pad 7 is made of a viscoelastic material as permanent non-elastic deformation will result. Likewise, channel bracket 6 is sized and angle brackets 5 positioned such that solid contact is made with edge decoupling pad 8, yet said edge decoupling pad 8 remains in a substantially non-compressed state. This is particularly critical when edge decoupling pad 8 is made of a viscoelastic material as permanent non-elastic deformation will result.

With continued reference to FIG. 3, it is noted that front and rear strawboard panels 2, 3 are essentially identical as are their respective attachment means, thus a finished wall will possess two identical outside faces. It can be seen that center strawboard panels 4 are positioned to substantially span the distance between the webs of adjacent I-beams and will typically be sized slightly shorter than front and rear strawboard panels 2, 3. The vertical edges of each center strawboard panel 4 will be covered by an edge decoupling pad 8 prior to insertion into a channel bracket 6 or placement between angle brackets 5. It can be seen that the tapping screws 10 which secure angle brackets 5 and channel bracket 6 are offset and will attach to I-beam 1 at different lateral locations. Further, the elevation of these attachment points can easily be varied such that the three tapping screws 10 illustrated on FIG. 3 will not necessarily fall in horizontal plane. Likewise, the elevation of lag screws 11 used to make connection between retainer plates 9 and front and rear panels 2,3 may be varied and do not necessarily need to fall within horizontal alignment.

In the preferred embodiment, strawboard panel 2,3,4 will be comprised of compressed recovered wheat straw held within a paperboard liner comprised of kraft or recycled paper having a basis weight greater that 69 lbs./msf., and the overall panel dimension will be approximately 4 ft×8 ft×2½″. I-beams 1, retainer plates 9, angle brackets 5, and channel brackets 6, will be made from a metal or metal alloy. Flange decoupling pads 7 and edge decoupling pads 8 will be made from a soft resilient material, preferably a viscoelastic material, and more preferably a viscoelastic material having a loss tangent (tan d)>0.5. Retainer plates 9, angle brackets 5 and channel brackets 6 can easily be made from alternative materials such as polymers, but will preferably be made from materials with melting or combustion temperatures higher than that of mild steel.

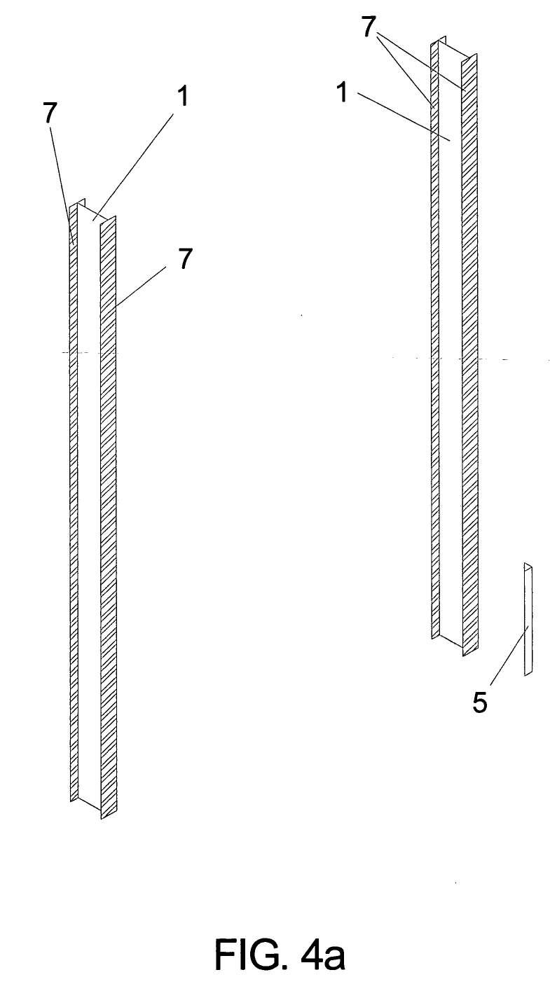

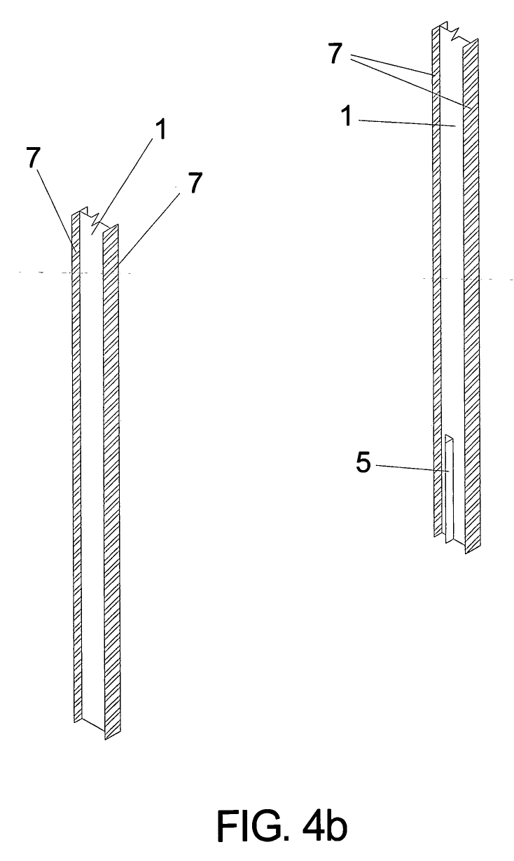

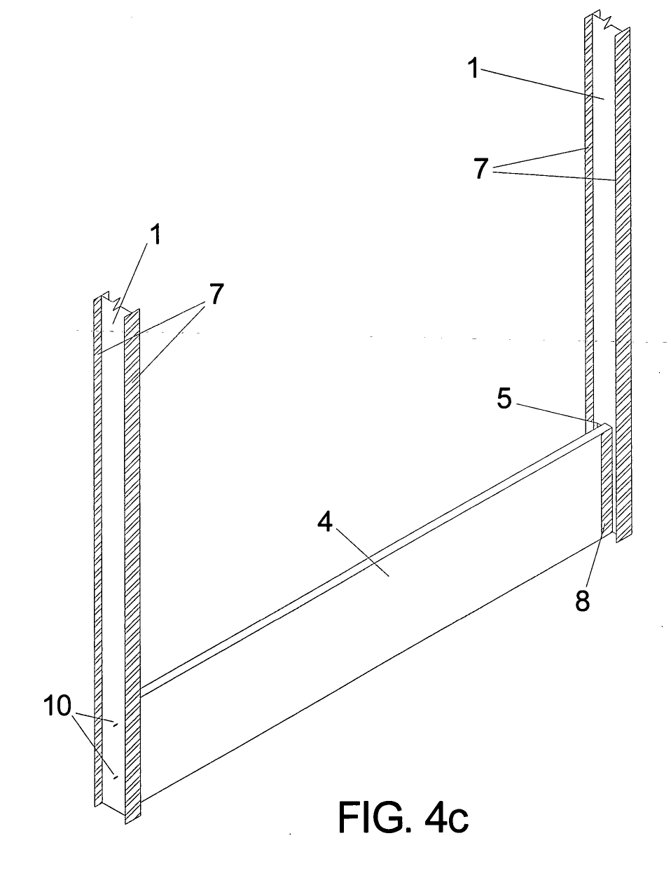

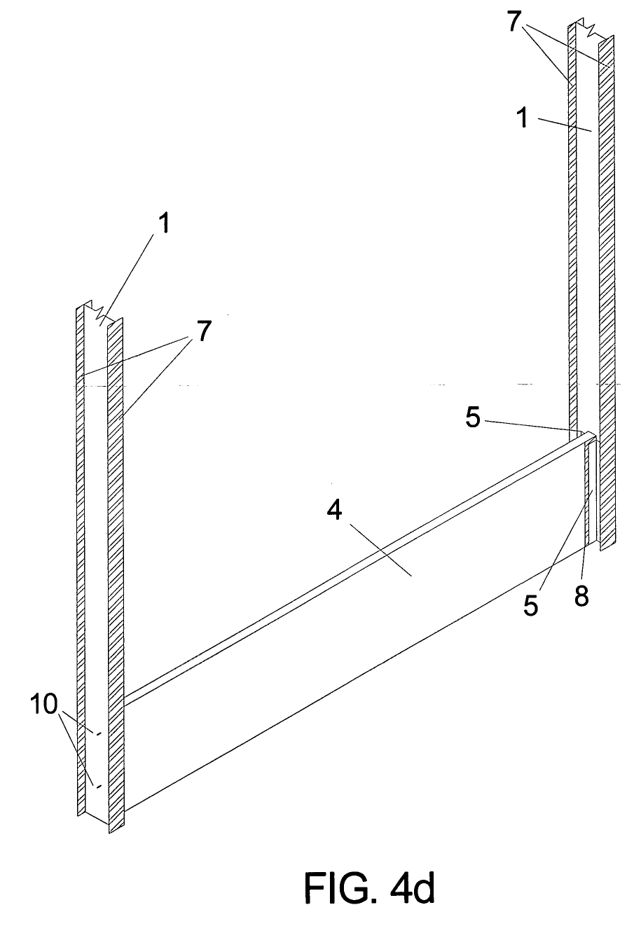

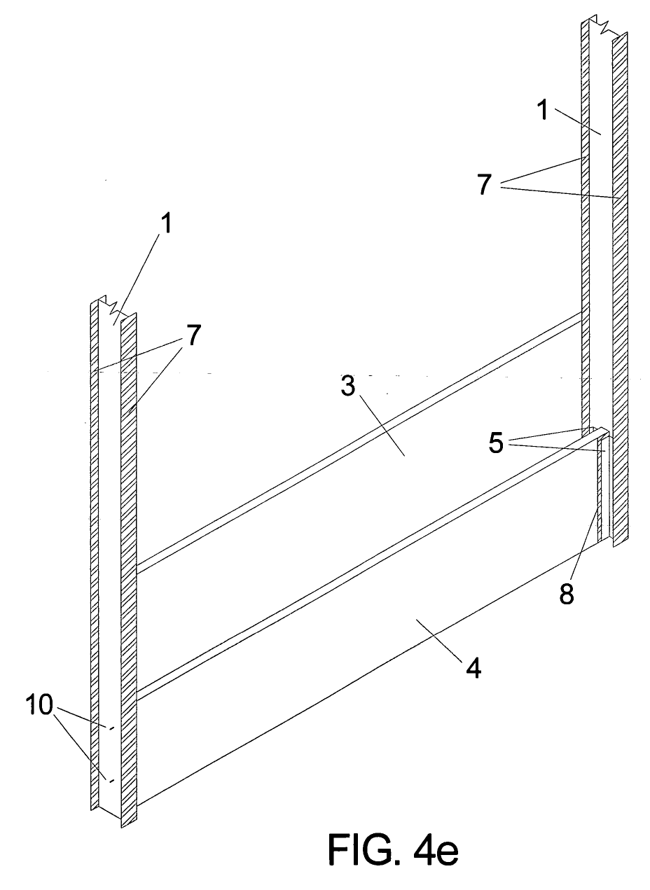

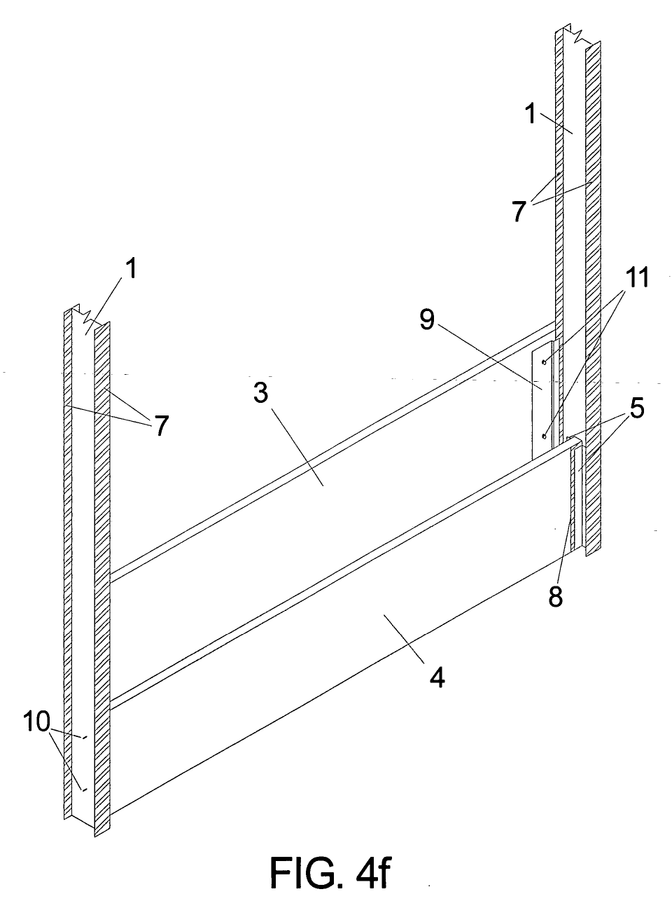

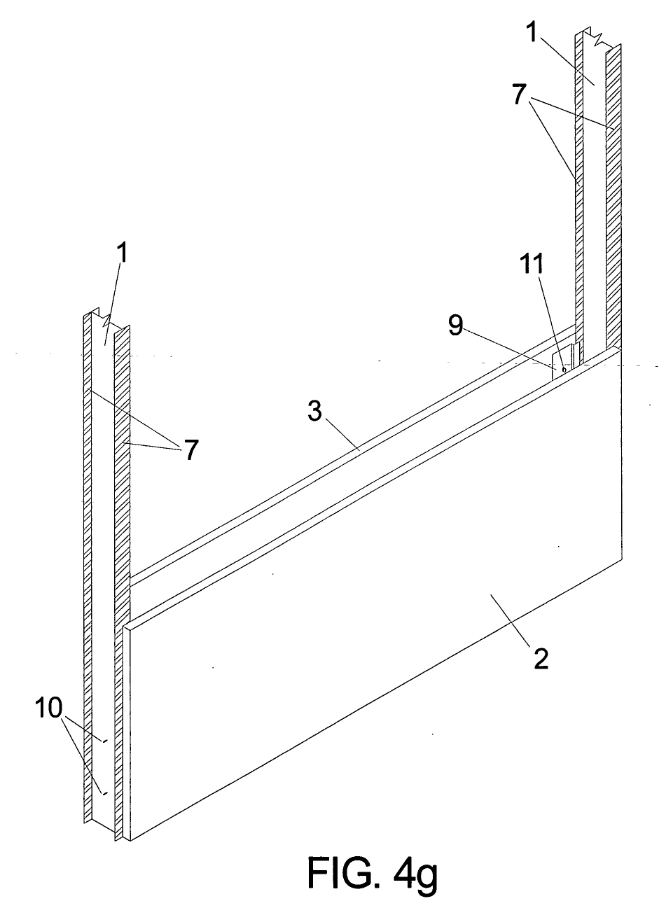

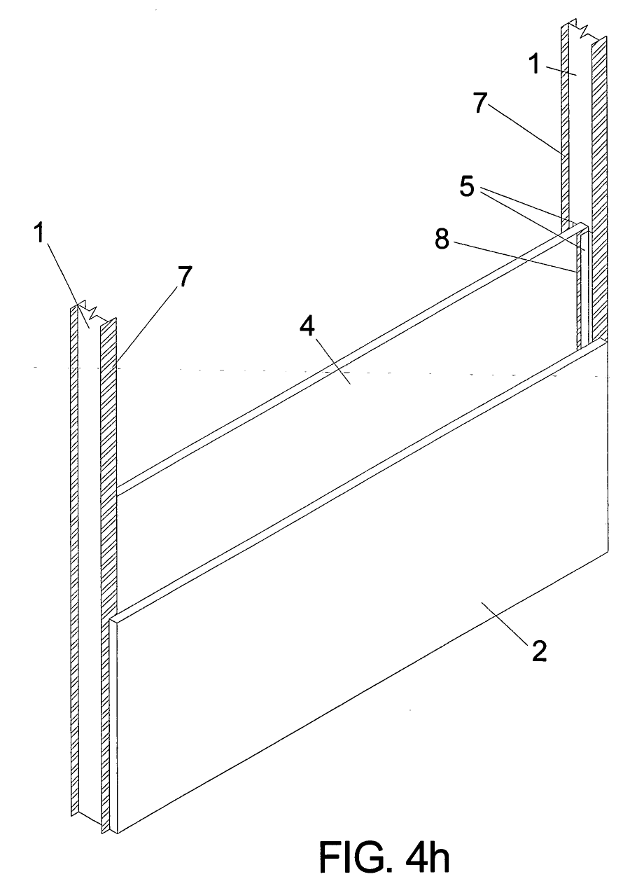

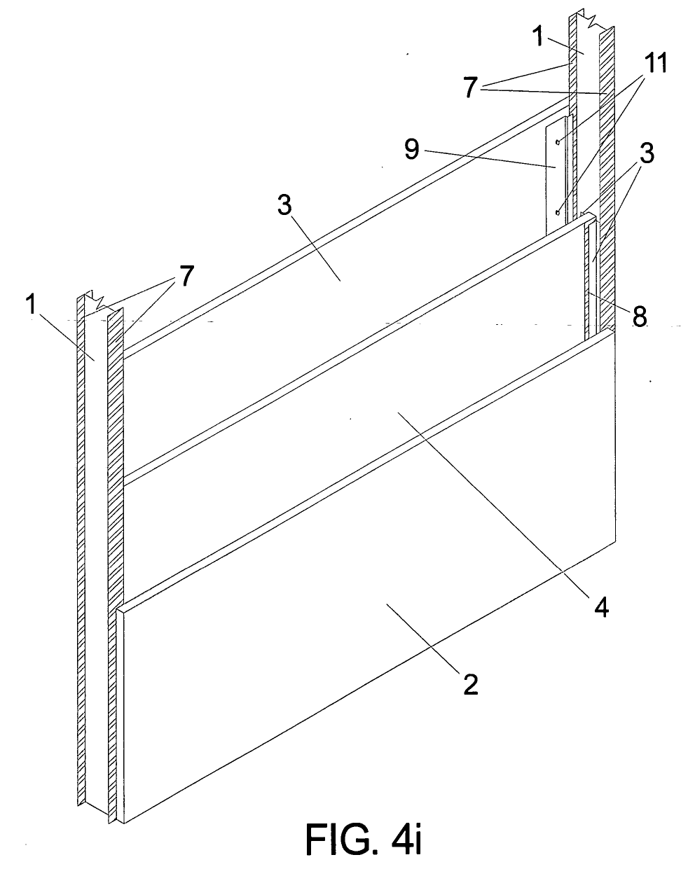

FIGS. 4a-4i illustrate the typical steps followed to construct a wall according to the preferred embodiment. The figures illustrate the very important characteristic of the present embodiment wherein the horizontal edge to edge joints between adjacent panels in the center are offset from those in the front and rear. This important characteristic eliminates the presence of an easy burn through route for a fire. As previously stated, each strawboard panel possesses a Class A flame spread rating, thus a composite wall comprising three layers of panels represents a formidable obstacle for fires.

FIG. 4a shows two adjacent I-beams 1 erected along a wall line and a first section of angle bracket 5 precut to size. Further, the flange sections of said I-beams 1 are each wrapped by a flange decoupling pad 7. FIG. 4b then shows angle bracket 5 from FIG. 4a properly installed and attached to I-beam 1. Though hidden from view, angle bracket 5 is attached to I-beam 1 by means of a plurality of tapping screws 10. Continuing,

FIG. 4c, then show the components from FIG. 4b wherein a first center strawboard panel is positioned for installation. An edge decoupling pad 8 is shown properly wrapped around the right horizontal edge of center panel 4, and a second edge decoupling pad 8 (not shown) is wrapped around the left edge of center panel 4. The left edge of center panel 4 is further held within a channel bracket 6 (not shown), and said channel bracket 6 (not shown) is attached to the left I-beam 1 by means of a plurality of tapping screws 10. Typically, the first center panel 4 in a wall section will be cut down so that the vertical height is approximately half that of a fill panel.

FIG. 4d shows the components of FIG. 4c wherein a second angle bracket 5 has been placed and attached to I-beam 1 by means of a plurality of tapping screws 10 (not shown).

FIG. 4e shows the components of FIG. 4d wherein a first rear strawboard panel 3 is positioned for attachment. FIG. 4f then shows the first rear panel 3 attached by means of a right retainer plate 9 and a left retainer plate (not shown), with both retainer plates attached to said rear panel 3 by means of a plurality of lag screws 11.

FIG. 4g shows the wall construction of FIG. 4f wherein a first front strawboard panel 2 has been positioned and attached. Though hidden from view, front panel 2 is attached by means of a right and left retainer plate 9 (not shown) with both retainer plates being attached to front panel 2 by means of a plurality of lag screws 11 (not shown).

FIG. 4h then shows the wall construction of FIG. 4g with a second center panel 4 installed and attached. It can be seen that the second center panel 4 is a full height panel, thus extends above the edges of the front and rear panels by approximately 50%. As previously mentioned, the noted offset between the front and rear panels and the center panels prevents any coinciding horizontal joints that would present an easy burn through path for a fire. FIG. 4i then shows a second rear strawboard panel 3 properly installed and attached. By examination of FIGS. 4a-4i in sequence, the step-wise process followed to erect a wall according to the preferred embodiment becomes clear.

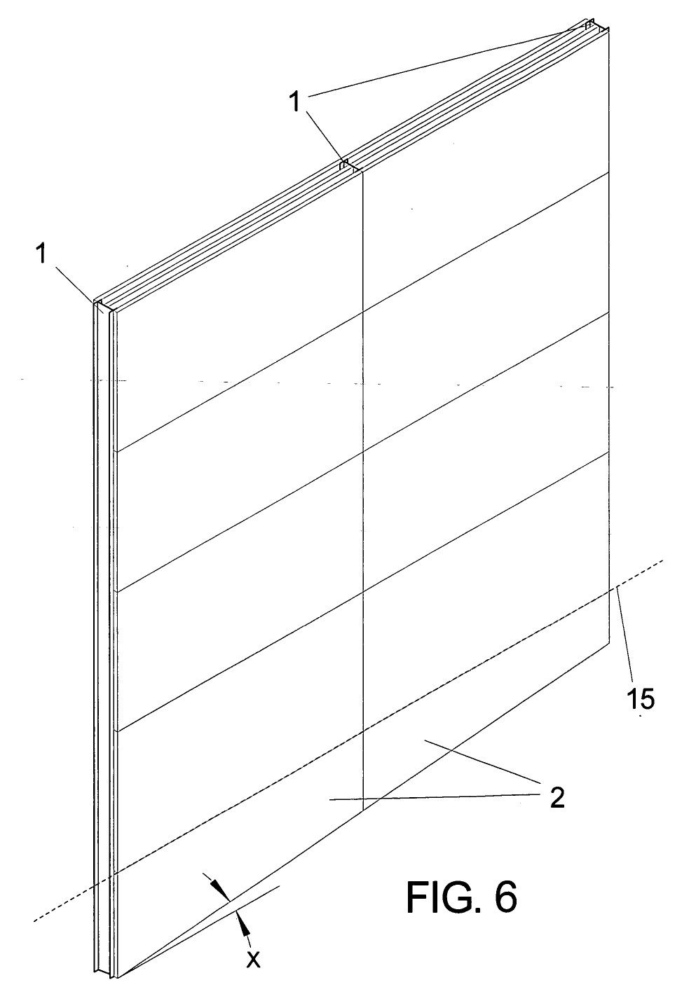

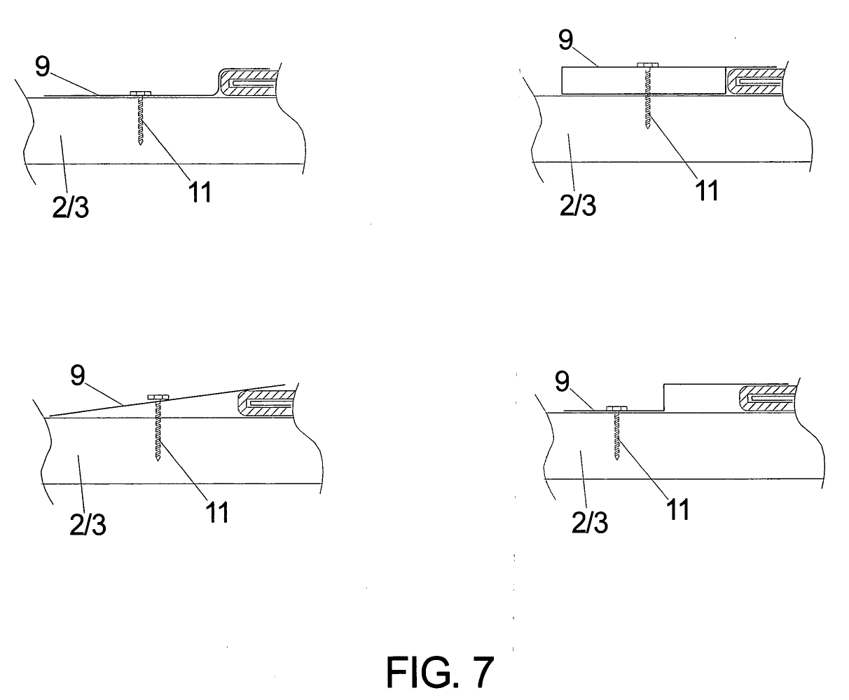

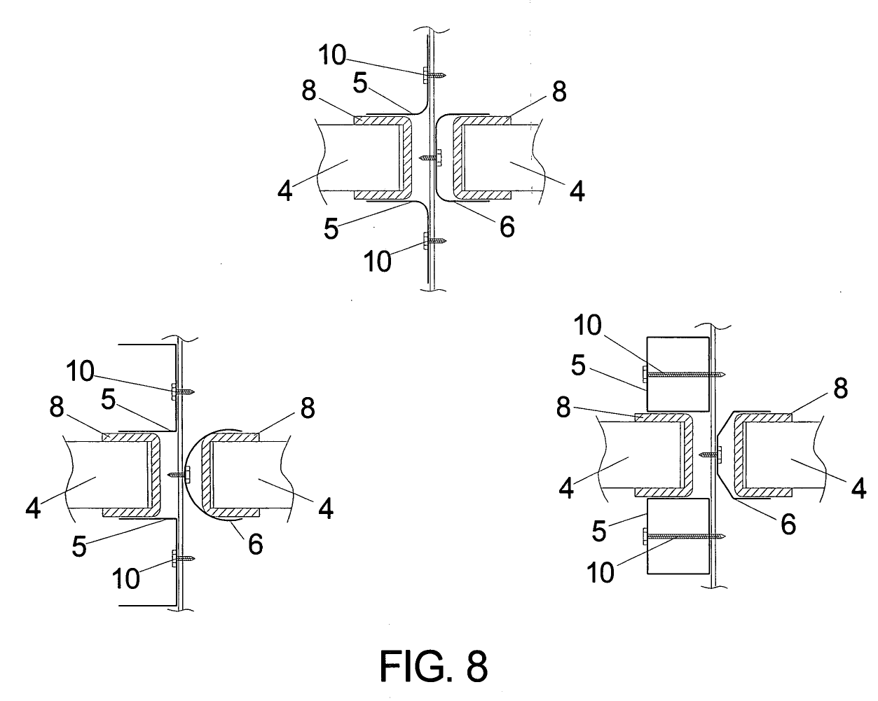

The subject embodiments are especially adaptable to structures such as theaters wherein the floor is sloped. FIG. 6 shows a wall construction built on a sloped floor. To accommodate a sloped floor, the bottom panels 2 (3,4 hidden from view) will be angle cut such that the upper edge line 15 is horizontal and perpendicular to vertical beams 1. The cut angle X will be equal to the grade or slope of the structure floor.

Though the subject invention is illustrated herein using compressed strawboard panels exclusively, any modular panel that can be suitably attached to the subject beams and brackets, and more importantly, possesses the desired acoustical properties can be used in accordance with the subject embodiments disclosed herein.

The dimensions of the walls including the panels, beams, angle and channel brackets and various connectors shown herein were selected for illustrative purposes only. The actual dimensions of each element may vary and is largely subject to the needs of each individual application. Further, The embodiments shown and described above are exemplary.

Even though numerous characteristics and advantages of the present embodiments have been described in the drawings and accompanying text, the description is illustrative only, and changes may be made in the detail, especially in matters of shape, size, and arrangement of the parts within the spirit and scope of the present invention, as determined by the following claims.

What is claimed is:

1. An improved building structure comprising:
a plurality of parallel support beams positioned along a wall line and further defining a first and second wall face, each beam further comprising two opposed lateral flange members and a center web member therebetween;
a plurality of resilient flange pads, said pads substantially covering the outer surface of lateral flange members of said support beams;
a first face panel having a substantially rectangular shape with a top, bottom, front and rear edge, and an inner and outer face, said first panel positioned against and partially overlapping the lateral flange member of two adjacent support beams along said first wall face;
a second face panel having a substantially rectangular shape with a top, bottom, front and rear edge, and an inner and outer face, said second panel positioned against and partially overlapping the lateral flange members of two adjacent support beams along said second wall face and in juxtaposed relation to said first face panel;
panel attachment means for attaching said first and second panels to said adjacent support beams;
a center panel having a substantially rectangular shape with a top, bottom, front and rear edge, and an inner and outer face, said center panel positioned to span between the center web members of two adjacent support beams and further positioned between said first and second face panels;
a plurality of resilient edge pads, said edge pads substantially covering the front and rear edges of said center panel;
a front edge connection means for attaching said front edge of said center panel to a support beam; and
a rear edge connection means for attaching said rear edge of said center panel to a support beam.

2. The structure of claim 1 wherein said center panel is offset such that only a portion of said center panel is located between said first and second face panels.

3. The structure of claim 1 wherein said panel attachment means is further comprising:
a substantially flat plate member, said plate member substantially aligned with and overlaying the overlapping joint between said panel and said lateral flange member of said support beam; and
plate connector means for attaching said plate member to said panel.

4. The structure of claim 3 wherein said plate connector means further comprises a penetrating connector with said penetrating connectors penetrating through said plate member and terminating within said panel.

5. The structure of claim 4 wherein said penetrating connector is selected from the group of a nail, screw, bolt, lag screw, rivet, staple, pin, or dowel.

6. The structure of claim 3 wherein said plate connector means further comprises a non-penetrating connector.

7. The structure of claim 6 wherein said non-penetrating connector is selected from the group of adhesive, tape, or glue.

8. The structure of claim 1 wherein said front edge connection means is further comprising:
a channel member, said channel member having opposed lateral walls and a base member therebetween, with said lateral walls sized to accept a front edge of said center panel therebetween; and
channel member connection means for attaching said channel member to a center web member of a support beam.

9. The structure of claim 8 wherein said channel member connection means further comprises at least one penetrating connector with each penetrating connector penetrating through said base member of said channel member and making attachment to said center web member of a support beam.

10. The structure of claim 9 wherein said penetrating connector is selected from the group of a nail, screw, bolt, lag screw, rivet, staple, pin, or dowel.

11. The structure of claim 8 wherein said channel member connection means further comprises a non-penetrating connector.

12. The structure of claim 11 wherein said non-penetrating connector is selected from the group of adhesive, tape, glue, braze, or weld.

13. The structure of claim 1 wherein said rear edge connection means is further comprising:
a pair of opposed rail members each having a substantially flat wall member and a base member, said rail members relatively situated such that said wall members are positioned to accept the rear edge of a center panel therebetween; and
rail member connection means for attaching said rail members to a center web of a support beam.

14. The structure of claim 13 wherein said rail member connection means further comprises at least one penetrating connector with each penetrating connector penetrating through said base member of said rail member and making attachment to said center web member of a support beam.

15. The structure of claim 14 wherein said penetrating connector is selected from the group of a nail, screw, bolt, lag screw, rivet, staple, pin, or dowel.

16. The structure of claim 13 wherein said rail member connection means further comprises a non-penetrating connector.

17. The structure of claim 16 wherein said non-penetrating connector is selected from the group of adhesive, tape, glue, braze or weld.

18. The structure of claim 1 wherein said flange pads are comprised of a substantially elastic material.

19. The structure of claim 1 wherein said flange pads are comprised of a substantially viscoelastic material.

20. The structure if claim 19 wherein said flange pads are comprised of a viscoelastic material having a loss tangent equal to or greater than 0.5.

21. The structure of claim 1 wherein said flange pads are pre-formed to fit said lateral flange members of said support beams.

22. The structure of claim 1 wherein said flange pads further comprise an adhesive face suitable for adhering to said lateral flange members of said support beams.

23. The structure of claim 1 wherein said edge pads are comprised of a substantially elastic material.

24. The structure of claim 1 wherein said edge pads are comprised of a substantially viscoelastic material.

25. The structure if claim 24 wherein said edge pads are comprised of a viscoelastic material having a loss tangent equal to or greater than 0.5.

26. The structure of claim 1 wherein said edge pads are pre-formed to fit said front and rear edge of said center panel.

27. The structure of claim 1 wherein said edge pads further comprise an adhesive face suitable for adhering to said front and rear edge of said center panel.
